(19) United States
(12) Patent Application Publication
(10) Pub. No.: US 2026/0236197 A1
(43) Pub. Date: Aug. 13, 2026

(54) NON-TRANSITORY RECORDING MEDIUM, INFORMATION PROCESSING APPARATUS, AND ELECTRONIC DEVICE

(71) Applicant: PFU Limited, ISHIKAWA (JP)

(72) Inventors: Yuya NISHITANI, ISHIKAWA (JP); Daiki KAWAI, ISHIKAWA (JP); Tomoaki WADA, ISHIKAWA (JP)

(21) Appl. No.: 19/451,598

(22) Filed: Jan. 16, 2026

(30) Foreign Application Priority Data
Feb. 13, 2025 (JP) 2025-021712
Oct. 7, 2025 (JP) 2025-169397

(51) Int. Cl. G06F 3/12

(52) U.S. Cl. CPC G06F 3/1205; G06F 3/1247; G06F 3/1258

(57) ABSTRACT

A non-transitory recording medium storing a plurality of instructions which, when executed by one or more processors on an information processing apparatus, causes the one or more processors to perform a method including: acquiring setting information related to an application that processes electronic data generated by an electronic device; identifying a program to be executed to use the application based on the setting information; and acquiring the identified program.

### CROSS-REFERENCE TO RELATED APPLICATIONS

This patent application is based on and claims priority pursuant to 35 U.S.C. §119(a) to Japanese Patent Application Nos. 2025-021712, filed on February 13, 2025, and 2025-169397, filed on October 7, 2025, in the Japan Patent Office, the entire disclosure of which is hereby incorporated by reference herein.

### BACKGROUND

The present disclosure relates to a non-transitory recording medium, an information processing apparatus, and an electronic device.

There is a technique for distributing electronic data for causing an electronic device to operate. For example, there is an information processing system that manages combined information of a description file and an application. The description file defines an operation procedure. The application is executed by an image processing apparatus to reproduce the description file.

### SUMMARY

A non-transitory recording medium according to one aspect of the present disclosure stores a plurality of instructions which, when executed by one or more processors, causes the one or more processors to perform a method including acquiring setting information related to an application that processes electronic data generated by an electronic device; identifying a program to be executed to use the application based on the setting information; and acquiring the identified program.

An information processing apparatus according to another aspect of the present disclosure includes circuitry that acquires setting information related to an application that processes electronic data generated by an electronic device; identifies a program to be executed to use the application based on the setting information; and acquires the identified program.

An electronic device according to still another aspect of the present disclosure includes circuitry that generates electronic data; acquires setting information related to an application that processes the electronic data; identifies a program to be executed to use the application based on the setting information; and acquires the identified program.

An information processing apparatus according to still another aspect of the present disclosure includes circuitry that transmits setting information related to an application that processes electronic data generated by an electronic device to another information processing apparatus; and transmits a program to be executed to use the application to another information processing apparatus. The setting information includes information for identifying the program.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of the general arrangement of a profile distribution system;

FIG. 2 is a block diagram illustrating an example of a hardware configuration of a computer;

FIG. 3 is a block diagram illustrating an example of a functional configuration of the profile distribution system;

FIG. 4 is a diagram illustrating an example of a category selection screen;

FIG. 5 is a diagram illustrating an example of a profile list screen;

FIG. 6 is a diagram illustrating an example of a detailed profile screen;

FIG. 7 is a first diagram illustrating an example of a screen of scanner software;

FIG. 8 is a second diagram illustrating an example of the screen of the scanner software;

FIG. 9 is a flowchart of an example of a profile distribution method;

FIG. 10 is a flowchart of an example of the profile distribution method; and

FIG. 11 is a flowchart of an example of an image reading method.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms "a," "an," and "the" are intended to include the plural forms as well, unless the context clearly indicates otherwise.

An example of an information processing system according to an embodiment of the present disclosure distributes setting information related to an electronic device. Hereinafter, the setting information related to an electronic device is also referred to as a "profile". The information processing system according to the present embodiment is also referred to as a "profile distribution system".

A profile is electronic data representing setting information related to an electronic device. Examples of the electronic device include office equipment, a home appliance, and facility equipment. The electronic device may be, for example, an image reading device such as a scanner. The electronic device is not limited to an image reading device. Examples of the electronic device include an image forming device such as a printer, a facsimile machine, or a digital multifunction peripheral/product/printer (MFP).

Software for using a scanner from an information processing terminal such as a personal computer or a smartphone is used. Hereinafter, the software for using a scanner is referred to as "scanner software". A user of a scanner operates the scanner software to create and use a profile related to the scanner.

A profile may include a setting related to another application. Another application may be an application for processing electronic data generated by the electronic device. The profile may include a setting item for linking an application (e.g., the scanner software) to another application. Hereinafter, another application is also referred to as a "link application".

Some setting items for linking an application to the link application involve a process that is not implemented by the profile alone. For example, the link application may use a unique communication scheme for data transmission and reception. For example, the link application supports only the image quality or the file format that is not supported by the scanner. In these cases, to link the scanner software to the link application, another program for expanding the function of the scanner software is incorporated. Hereinafter, another program is also referred to as a "relay program".

In the related art, an information communication service is used for distributing software to be installed on an information processing apparatus or setting information of the software. The profile is distributable via the information communication service of this kind. However, when the profile includes a setting item that involves the relay program, distribution of the profile alone may fail to implement linkage between the scanner software and the link application. In this case, a user of the scanner software separately acquires the relay program, and manually installs the relay program on the information processing apparatus on which the user uses the scanner software. The user of the scanner software desirably has knowledge of acquiring and installing the relay program. Thus, in the related art, there is room for improvement in convenience in acquisition of a profile.

Embodiments of the present disclosure improve the convenience in acquisition of a profile. According to an embodiment of the present disclosure, a profile including a setting related to a link application that processes image data generated by a scanner is acquired. Based on the profile, a relay program to be executed to use the link application is identified. The identified relay program is acquired.

In one aspect, the embodiment of the present disclosure omits the necessity of separately acquiring the relay program to be executed to use the link application when the profile including the setting related to the link application is acquired. Thus, the embodiment of the present disclosure improves the convenience in acquisition of a profile.

### General Arrangement

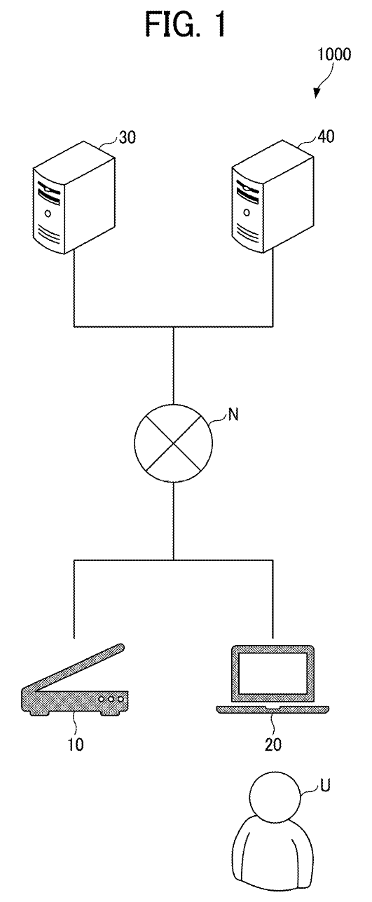

A general arrangement of a profile distribution system according to an embodiment of the present disclosure will be described with reference to FIG. 1. FIG. 1 is a diagram illustrating an example of the general arrangement of the profile distribution system.

As illustrated in FIG. 1, a profile distribution system 1000 includes a scanner 10, a user terminal 20, a distribution server 30, and a link server 40. The scanner 10 is an example of an electronic device. The user terminal 20 is an example of an information processing apparatus. The distribution server 30 includes a storage device that is external to the user terminal 20, which may be implemented by any desired memory. The link server 40 is an example of another information processing apparatus other than the user terminal 20.

The scanner 10, the user terminal 20, the distribution server 30, and the link server 40 are connected to one another via a communication network N for data communication. The communication network N may be a communication network such as a local area network (LAN), a virtual private network (VPN), or the Internet. The communication network N may include a wired or wireless communication network. The communication network N may include a serial communication network, for example, using a Universal Serial Bus (USB) cable.

The scanner 10 is an example of an image reading device that optically reads an image formed on an image forming medium. The scanner 10 outputs image data read from the image forming medium. The scanner 10 performs data processing such as optical character recognition (OCR) on the image data read from the image forming medium and output the processing result. The scanner 10 transmits the image data or the processing result of the image data to the user terminal 20 via the communication network N.

The user terminal 20 is an example of an information processing apparatus such as a personal computer, a smartphone, or a tablet terminal that is operated by a user U of the scanner 10. The scanner software is installed on the user terminal 20. The user U operates the scanner software to carry out a function such as a function for creating or using a profile.

An import tool may be installed on the user terminal 20. The import tool is a program for installing the profile and the relay program on the user terminal 20. The import tool may be integrated into the scanner software as one function of the scanner software.

The distribution server 30 is an example of an information processing apparatus such as a server, a workstation, or a personal computer that distributes a profile. The distribution server 30 includes a storage device and stores a profile created in advance in the storage device. In response to a request from the user terminal 20, the distribution server 30 transmits the profile read from the storage device to the user terminal 20.

The distribution server 30 may provide an information communication service for distributing profiles. Hereinafter, the information communication service for distributing profiles is also referred to as a "profile store". The profile store may distribute, along with a profile, a relay program used in the profile. The profile store provides profiles for free in one embodiment or for a fee in another embodiment.

The link server 40 is an example of an information processing apparatus such as a server, a workstation, or a personal computer that executes a link application. The link server 40 executes a link application that processes image data generated by the scanner 10. In response to a request from the user terminal 20, the link server 40 executes the link application that processes the image data.

In one example, the link application may implement a business card management service that manages image data of business cards read by the scanner 10. In another example, the link application may implement a household account service that manages image data of receipts read by the scanner 10. In still another example, the link application may implement a photograph management service that manages image data of photographs developed on printing paper and read by the scanner 10. The link application is not limited to the above examples, and examples of the link application may include various applications that process image data generated by the scanner 10.

In the present embodiment, the user U operates the user terminal 20 to cause the profile to be distributed to the user terminal 20. The user U may operate the scanner 10 to cause the profile to be distributed to the scanner 10, or operate the user terminal 20 to cause the profile to be distributed to the scanner 10. The scanner 10 and the user terminal 20 may be installed in the same space in one embodiment or in different spaces in another embodiment.

The general arrangement of the profile distribution system 1000 illustrated in FIG. 1 is an example, and various system configuration examples may occur depending on the use or purpose. For example, the profile distribution system 1000 may include two or more scanners 10 or two or more user terminals 20. For example, the distribution server 30 or the link server 40 may be implemented by multiple computers in one embodiment or as a cloud computing service in another embodiment. The classification of the apparatuses such as the scanner 10, the user terminal 20, the distribution server 30, and the link server 40 illustrated in FIG. 1 is an example.

### Hardware Configuration

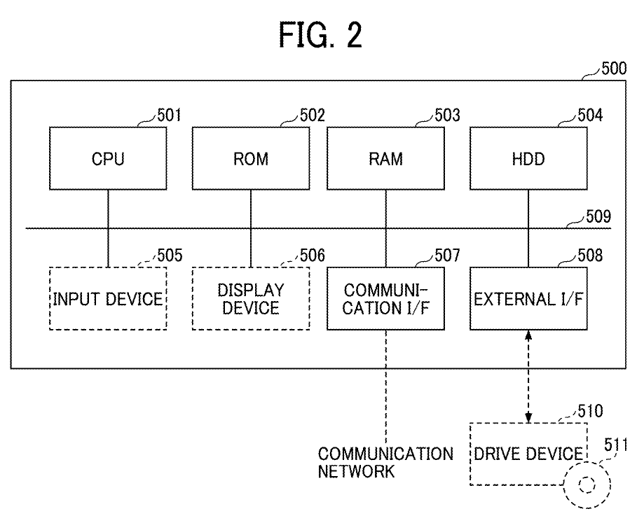

A hardware configuration of the profile distribution system 1000 will be described with reference to FIG. 2. The user terminal 20, the distribution server 30, and the link server 40 may be each implemented by, for example, a computer. FIG. 2 is a block diagram illustrating an example of a hardware configuration of the computer.

As illustrated in FIG. 2, a computer 500 includes a central processing unit (CPU) 501, a read-only memory (ROM) 502, a random access memory (RAM) 503, a hard disk drive (HDD) 504, an input device 505, a display device 506, a communication interface (I/F) 507, and an external I/F 508. The CPU 501, the ROM 502, and the RAM 503 form a so-called computer. The hardware components of the computer 500 are connected to one another via a bus line 509. The input device 505 and the display device 506 may be connected to the computer 500 via the external I/F 508 for use.

The CPU 501 is a processing unit that reads programs or data from a storage device such as the ROM 502 or the HDD 504 into the RAM 503 and executes processes based on the programs or data to control the computer 500 or implement functions of the computer 500. The computer 500 may include a graphics processing unit (GPU) in addition to or instead of the CPU 501.

The ROM 502 is an example of a nonvolatile semiconductor memory (storage device) that retains programs or data even after the power is turned off. The ROM 502 functions as a main storage device that stores various programs or data used by the CPU 501 to execute the various programs installed on the HDD 504. Specifically, the ROM 502 stores boot programs such as a basic input/output system (BIOS) and an extensible firmware interface (EFI), which are executed at the time of booting the computer 500, and data such as operating system (OS) settings and network settings.

The RAM 503 is an example of a volatile semiconductor memory (storage device) from which programs or data are erased when the power is turned off. The RAM 503 is, for example, a dynamic random access memory (DRAM) or a static random access memory (SRAM). The RAM 503 provides a work area to which various programs installed on the HDD 504 are loaded when the programs are executed by the CPU 501.

The HDD 504 is an example of a nonvolatile storage device that stores programs or data. The programs or data stored in the HDD 504 include an OS that is basic software for controlling the computer 500 and applications that provide various functions on the OS. The computer 500 may use a storage device (e.g., a solid state drive (SSD)) using a flash memory as a storage medium, instead of the HDD 504.

The input device 505 is used by a user to input various signals. Examples of the input device 505 include a touch panel, operation keys or buttons, a keyboard, a mouse, and a microphone for inputting sound data such as voice.

The display device 506 includes a display such as a liquid crystal display or an organic electroluminescence (EL) display that displays a screen, and a speaker that outputs sound data such as voice.

The communication I/F 507 is an interface for connecting the computer 500 to a communication network to allow the computer 500 to perform data communication.

The external I/F 508 is an interface between the computer 500 and an external device. Examples of the external device include a drive device 510.

The drive device 510 is a device to which a recording medium 511 is placed. Examples of the recording medium 511 include media that optically, electrically, or magnetically record information, such as a compact disc read-only memory (CD-ROM), a flexible disk, and a magneto-optical disk. Examples of the recording medium 511 may also include a semiconductor memory that electrically records information, such as a ROM or a flash memory. The external I/F 508 allows the computer 500 to read or write data from or to the recording medium 511.

For example, the distributed recording medium 511 may be inserted into the drive device 510 connected to the external I/F 508, and the drive device 510 reads the various programs recorded on the recording medium 511, so that the various programs are installed on the HDD 504. Alternatively, the various programs may be downloaded from another network different from the communication network via the communication I/F 507, so that the various programs are installed on the HDD 504.

### Functional Configuration

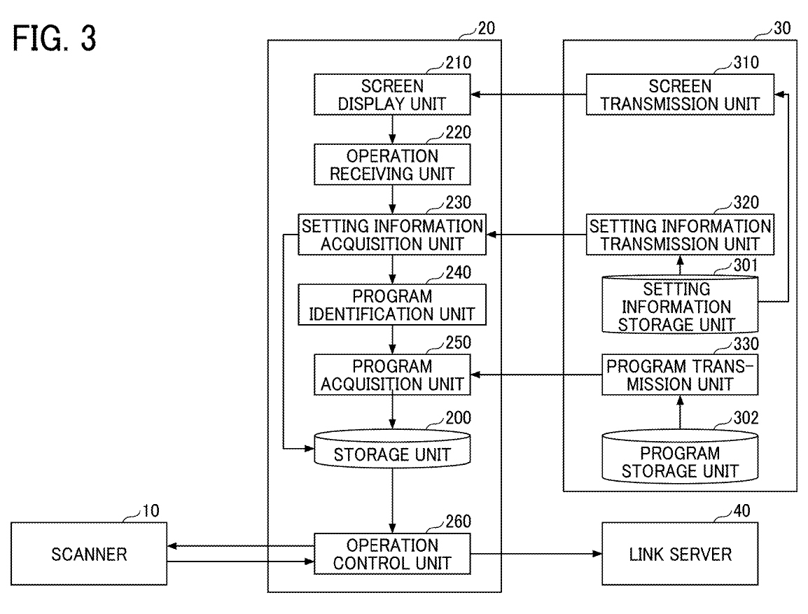

A functional configuration of the profile distribution system 1000 will be described with reference to FIG. 3. FIG. 3 is a block diagram illustrating an example of the functional configuration of the profile distribution system.

### Distribution Server

As illustrated in FIG. 3, the distribution server 30 includes a setting information storage unit 301, a program storage unit 302, a screen transmission unit 310, a setting information transmission unit 320, and a program transmission unit 330. The distribution server 30 executes a distributed program preinstalled thereon to function as the setting information storage unit 301, the program storage unit 302, the screen transmission unit 310, the setting information transmission unit 320, and the program transmission unit 330.

For example, the setting information storage unit 301 and the program storage unit 302 are implemented by the HDD 504 illustrated in FIG. 2. For example, the screen transmission unit 310, the setting information transmission unit 320, and the program transmission unit 330 are implemented by processes executed by the CPU 501 based on a program loaded to the RAM 503 from the HDD 504 illustrated in FIG. 2.

The setting information storage unit 301 stores a profile. In one example, the setting information storage unit 301 stores a profile created in advance. In another example, the setting information storage unit 301 stores a profile input via the input device 505 of the distribution server 30. In another example, the setting information storage unit 301 stores a profile received by the distribution server 30 via the communication network N.

The setting information storage unit 301 stores a profile distributed to the user terminal 20 via the profile store. The profile provided via the profile store may be created by a user or an administrator of the distribution server 30 or by a user or an administrator of the link server 40.

The profile includes a setting item related to a link application. The setting item related to a link application includes identification information of a relay program used by the link application. The identification information of a relay program may be location information for acquiring the relay program. The location information is, for example, information indicating a location of the relay program on the communication network N. The location information is, for example, a uniform resource locator (URL).

The program storage unit 302 stores a relay program. In one example, the program storage unit 302 stores a relay program created in advance. In another example, the program storage unit 302 stores a relay program input via the input device 505 of the distribution server 30. In another example, the program storage unit 302 stores a relay program received by the distribution server 30 via the communication network N.

The program storage unit 302 stores a relay program used in a profile distributed via the profile store. The relay program stored in the program storage unit 302 may be created by a user or an administrator of the distribution server 30 or by a user or an administrator of the link server 40.

The screen transmission unit 310 transmits screen data. In response to a request from the user terminal 20, the screen transmission unit 310 transmits screen data to the user terminal 20. For example, the screen transmission unit 310 transmits screen data for displaying a screen of the profile store. The screen data is, for example, electronic data written in HyperText Markup Language (HTML), and may include a program written in a script language such as JavaScript^{®}. The screen transmission unit 310 may be implemented by, for example, a web server or an application server.

The setting information transmission unit 320 transmits a profile. In response to a request from the user terminal 20, the setting information transmission unit 320 transmits a profile to the user terminal 20. The setting information transmission unit 320 reads, from the setting information storage unit 301, a profile requested by the user terminal 20. The setting information transmission unit 320 transmits the profile read from the setting information storage unit 301 to the user terminal 20.

The program transmission unit 330 transmits a relay program. In response to a request from the user terminal 20, the program transmission unit 330 transmits a relay program to the user terminal 20. The program transmission unit 330 reads, from the program storage unit 302, a relay program requested by the user terminal 20. The program transmission unit 330 transmits the relay program read from the program storage unit 302 to the user terminal 20.

### User Terminal

As illustrated in FIG. 3, the user terminal 20 includes a storage unit 200, a screen display unit 210, an operation receiving unit 220, a setting information acquisition unit 230, a program identification unit 240, a program acquisition unit 250, and an operation control unit 260. The user terminal 20 executes a terminal program preinstalled thereon to function as the storage unit 200, the screen display unit 210, the operation receiving unit 220, the setting information acquisition unit 230, the program identification unit 240, the program acquisition unit 250, and the operation control unit 260.

For example, the storage unit 200 is implemented by the HDD 504 illustrated in FIG. 2. For example, the screen display unit 210, the operation receiving unit 220, the setting information acquisition unit 230, the program identification unit 240, the program acquisition unit 250, and the operation control unit 260 are implemented by processes executed by the CPU 501 based on a program loaded to the RAM 503 from the HDD 504 illustrated in FIG. 2.

The storage unit 200 stores a profile. In one example, the storage unit 200 stores a profile acquired by the setting information acquisition unit 230. In another example, the storage unit 200 stores a profile downloaded from the distribution server 30. In another example, the storage unit 200 stores a profile in advance.

The storage unit 200 stores a relay program. In one example, the storage unit 200 stores a relay program acquired by the program acquisition unit 250. In another example, the storage unit 200 stores a relay program downloaded from the distribution server 30. In another example, the storage unit 200 stores a relay program in advance.

The storage unit 200 stores the scanner software and the import tool. In one example, the storage unit 200 may store the scanner software and the import tool in advance. In another example, the storage unit 200 stores the scanner software and the import tool downloaded from the distribution server 30.

The screen display unit 210 displays the screen of the profile store on the display device 506. In one example, the screen display unit 210 displays the screen of the profile store, based on screen data received from the distribution server 30. The screen display unit 210 may be a web browser or an application having a browser function. The application having a browser function may be, for example, an application that displays web content using a web viewing function.

The screen display unit 210 displays the screen of the scanner software on the display device 506. The screen display unit 210 executes the scanner software read from the storage unit 200 to display the screen of the scanner software.

The operation receiving unit 220 receives an operation performed by the user U. In one example, the operation receiving unit 220 receives an operation performed on the screen of the profile store displayed by the screen display unit 210. In another example, the operation receiving unit 220 receives an operation performed on the screen of the scanner software displayed by the screen display unit 210.

The setting information acquisition unit 230 acquires a profile. The setting information acquisition unit 230 may download a profile from the distribution server 30 via the communication network N. In another example, the setting information acquisition unit 230 downloads a profile in response to an operation performed on the screen of the profile store. The setting information acquisition unit 230 acquires a profile, based on identification information of the profile embedded in the screen of the profile store. The identification information of the profile may be location information for acquiring the profile.

The program identification unit 240 identifies a relay program. In one example, the program identification unit 240 identifies a relay program based on the profile acquired by the setting information acquisition unit 230. In another example, the program identification unit 240 identifies a relay program for using a link application. In another example, the program identification unit 240 identifies the relay program based on a setting item related to the link application included in the profile. The program identification unit 240 may acquire identification information of the relay program included in the profile to identify the relay program.

The program acquisition unit 250 acquires a relay program. The program acquisition unit 250 acquires the relay program identified by the program identification unit 240. The program acquisition unit 250 may download the relay program from the distribution server 30 via the communication network N. The program acquisition unit 250 may acquire the relay program, based on identification information of the relay program included in the profile.

The operation control unit 260 controls an operation of the scanner 10. In one example, the operation control unit 260 controls an operation of the scanner 10, based on the profile acquired by the setting information acquisition unit 230. In another example, the operation control unit 260 controls an operation of the scanner 10, based on the profile stored in the storage unit 200. In another example, the operation control unit 260 controls an operation of the scanner 10 in response to an operation performed on the screen of the scanner software.

The operation control unit 260 acquires image data generated by the scanner 10. The operation control unit 260 executes the relay program acquired by the program acquisition unit 250. The operation control unit 260 sets information related to the image data in the relay program. For example, the operation control unit 260 sets path information of the image data as an argument of the relay program and starts the relay program.

In one example, the relay program causes the image data generated by the scanner 10 to be transmitted to the link server 40. In another example, the relay program causes the image data generated by the scanner 10 to be converted into image data in a file format corresponding to the link application. In another example, the relay program causes the image data generated by the scanner 10 to be converted into image data having an image quality corresponding to the link application.

The scanner 10 includes the storage unit 200, the screen display unit 210, the operation receiving unit 220, the setting information acquisition unit 230, the program identification unit 240, the program acquisition unit 250, and the operation control unit 260. In this case, the user terminal 20 may be omitted from the profile distribution system 1000. When the scanner 10 includes the screen display unit 210, the screen of the profile store is displayed on a display of an operation panel of the scanner 10. The rest of the processing units have substantially the same configurations as those of the user terminal 20.

The functional configuration of the profile distribution system 1000 illustrated in FIG. 3 is an example, and various functional configuration examples may occur in accordance with the use or purpose. The classification of the processing units such as the storage unit 200, the screen display unit 210, the operation receiving unit 220, the setting information acquisition unit 230, the program identification unit 240, the program acquisition unit 250, the operation control unit 260, the setting information storage unit 301, the program storage unit 302, the screen transmission unit 310, the setting information transmission unit 320, and the program transmission unit 330 illustrated in FIG. 3 is an example.

### Specific Examples of Relay Program

Processing content of the relay program will be described in detail with reference to specific examples.

A first specific example is a relay program for supporting data transfer to a link application that requests a particular communication scheme. Some link applications use a particular communication scheme for data transfer. On the other hand, the communication schemes implemented by the scanner software are limited. The communication scheme may include an application programming interface (API) for causing the link application to perform data communication.

For example, linking the scanner software to a new application involves transferring data using a communication scheme requested by the new application. A relay program that enables data transfer using the communication scheme requested by the new application is incorporated into the scanner software. This makes it easier to link the scanner software to the new application without updating the entire scanner software.

A second specific example is a relay program for linking the scanner software to a household account service using a setting suitable for the household account service. Some household account services support OCR on image data on a receipt and checking or correction of the recognized result. However, the receipt has a greatly varying printing quality (e.g., easy-to-read property including the density).

Accordingly, to link the scanner software to the household account service, image data generated by the scanner 10 through reading preferably has an image quality suitable for the household account service. Specifically, a setting for enhancing text may be enabled or a binarization contrast may be increased. A profile for reading at a setting suitable for the household account service and a relay program for transferring data using a communication scheme requested by the household account service are distributed, so that the scanner software can be linked to the household account service.

A third example is a relay program for linking the scanner software to a photograph management service at a setting suitable for the photograph management service. Some photograph management services can tag persons by face recognition or allow manual organization of image data. In the photograph management service, electronic data obtained by a digital camera or a smartphone through image capturing and data digitized from photographs developed on print paper often coexist. Users of the photograph management service expect that photographs are digitized at an image quality that is as high as possible.

Accordingly, to link the scanner software to the photograph management service, photographs are preferably read at a setting suitable for photograph reading and the image quality of the resulting image data is correctable. Specifically, the compression ratio may be reduced or a setting for correcting fading of photographs may be enabled. A profile for reading at a setting suitable for photographs, a relay program for correcting image data into image data having an image quality suitable for the photograph management service, and a relay program for transferring data using a communication scheme requested by the photograph management service are distributed, so that the scanner software can be linked to the photograph management service.

A fourth specific example is a relay program for supporting a link application that requests a specific file format. The scanner software often supports only the classical file formats such as Joint Photographic Experts Group (JPEG), Tag Image File Format (TIFF), and Portable Document Format (PDF), for example. These file formats may have insufficient compression ratios as compared with new compression formats such as JPEG2000 and Joint Bi-level Image Experts Group (JBIG2), for example. Thus, the scanner software may fail to be linked to a service that supports only the new highly efficient compression formats.

Accordingly, a relay program for converting image data generated by a scanner into image data of a highly efficient compression format and a relay program for enabling data transfer using a communication scheme requested by the application are incorporated into the scanner software, so that the scanner software can be easily linked to a new application that supports only the highly efficient compression format without updating the entire scanner software.

### User Interface

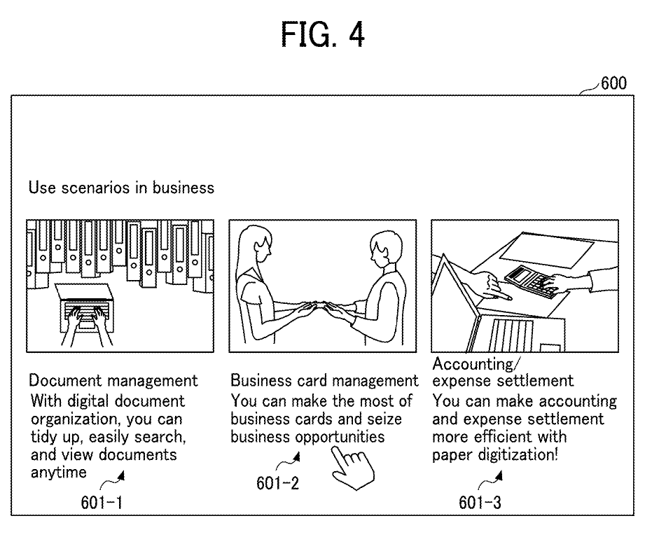

The user interface of the profile distribution system 1000 will be described with reference to FIGS. 4 to 8. The user interface of the profile distribution system 1000 includes the screen of the profile store and the screen of the scanner software.

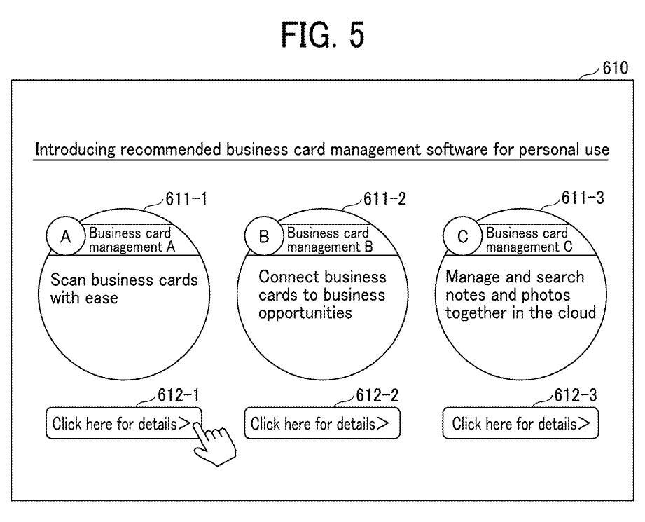

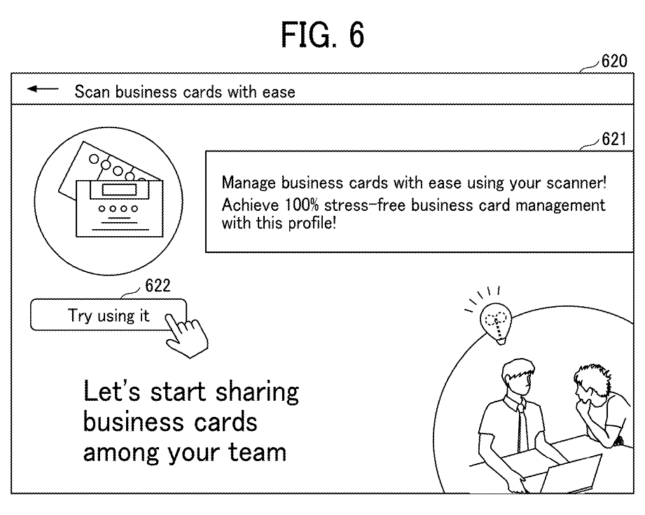

The screen of the profile store includes a category selection screen (see FIG. 4), a profile list screen (see FIG. 5), and a detailed profile screen (see FIG. 6). The category selection screen displays profile categories. The profile list screen displays a profile list. The detailed profile screen displays detailed information of a profile.

FIG. 4 is a diagram illustrating an example of the category selection screen. As illustrated in FIG. 4, a category selection screen 600 includes one or more category display areas 601 (601-1 to 601-3). The category display areas 601 display profile categories in a selectable manner. The profile categories may include the purposes, the use scenarios, and the target user of the profiles and the types of link applications.

For example, FIG. 4 illustrates three category display areas 601-1 to 601-3 based on the purposes (i.e., document management, business card management, and accounting/expense settlement) of profiles. FIG. 4 illustrates the state in which the category display area 601-2 representing business card management is selected. In response to one of the category display areas 601 being selected on the category selection screen 600, the category selection screen 600 changes to the profile list screen.

FIG. 5 is a diagram illustrating an example of the profile list screen. As illustrated in FIG. 5, a profile list screen 610 includes one or more profile display areas 611 (611-1 to 611- 3) and one or more display details buttons 612 (612-1 to 612-3). The profile display areas 611 display one or more profiles that belong to the category selected on the category selection screen 600. The display details buttons 612 are for displaying detailed information of the one or more profiles displayed in the respective profile display areas 611. The display details buttons 612 are associated with the respective profile display areas 611 each representing a profile whose detailed information is to be displayed.

For example, FIG. 5 illustrates three profile display areas 611-1 to 611-3 that belong to the business card management category. FIG. 5 illustrates a state in which the display details button 612-1 corresponding to the profile display area 611-1 is pressed. In response to one of the display details buttons 612 being pressed on the profile list screen 610, the profile list screen 610 changes to the detailed profile screen.

FIG. 6 is a diagram illustrating an example of the detailed profile screen. As illustrated in FIG. 6, a detailed profile screen 620 includes a details display area 621 and an acquire button 622. The details display area 621 displays detailed information of the profile. The detailed information of the profile may include a description of the link application. The description of the link application may include a method for using the link application.

The acquire button 622 is for acquiring the profile. That is, the acquire button 622 is for acquiring the profile that implements the method for using the link application. In the acquire button 622, identification information of the profile may be embedded. Specifically, in the acquire button 622, a link to a URL of the profile may be embedded. In response to an operation on the acquire button 622, the import tool installed on the user terminal 20 may start. For example, the acquire button 622 may use the URL scheme to start the import tool. After the import tool is started, downloading of the profile starts.

The screen of the profile store may include a screen corresponding to the scanner 10. For example, in response to the model of the scanner 10 being specified, the screen of the profile store may be controlled to display only the profiles that are usable on the model. The model of the scanner 10 may be specified by the user U of the scanner 10. For example, the screen of the profile store may include an input field to receive specification of the model of the scanner 10. The model of the scanner 10 may be automatically specified based on information related to the scanner 10. For example, the distribution server 30 may store the identification information of the scanner 10 in association with model information. Based on the identification information acquired from the scanner 10, the distribution server 30 may automatically specify the model of the scanner 10.

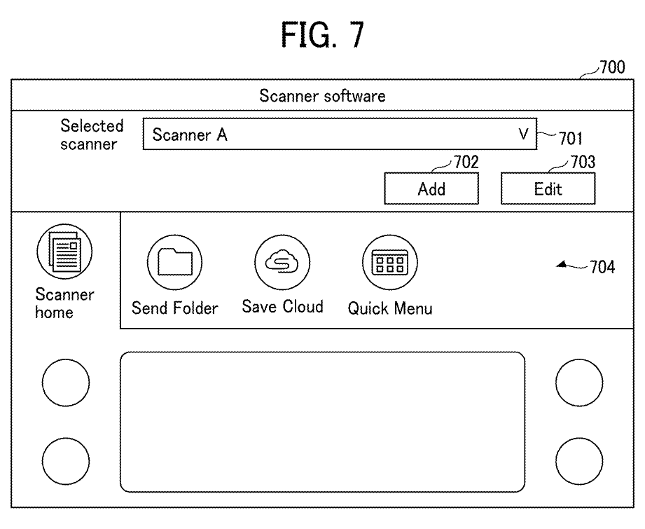

FIG. 7 is a first diagram illustrating an example of the screen of the scanner software. FIG. 7 illustrates an example of the screen of the scanner software displayed before a profile is distributed. As illustrated in FIG. 7, a screen 700 of the scanner software includes a scanner selection field 701, an add button 702, an edit button 703, and a profile display area 704.

The scanner selection field 701 is a screen component for selecting the scanner 10 to be controlled. The scanner selection field 701 displays information representing one or more scanners 10 set in advance in a selectable manner.

The add button 702 is for adding a profile to the scanner software. In response to the add button 702 being pressed, a screen for creating a new profile is displayed. This screen may display setting items included in the profile as blank fields or with initial values.

The edit button 703 is for editing the profile set in the scanner software. In response to the edit button 703 being pressed, a screen for editing the profile is displayed. This screen may display the already set setting values of the profile in an editable manner.

The profile display area 704 displays the already set profiles. The profile display area 704 displays information (e.g., icons or labels) representing the profiles stored in the storage unit 200. In response to one of the profiles being selected in the profile display area 704, the operation of the scanner 10 is controlled based on the selected profile.

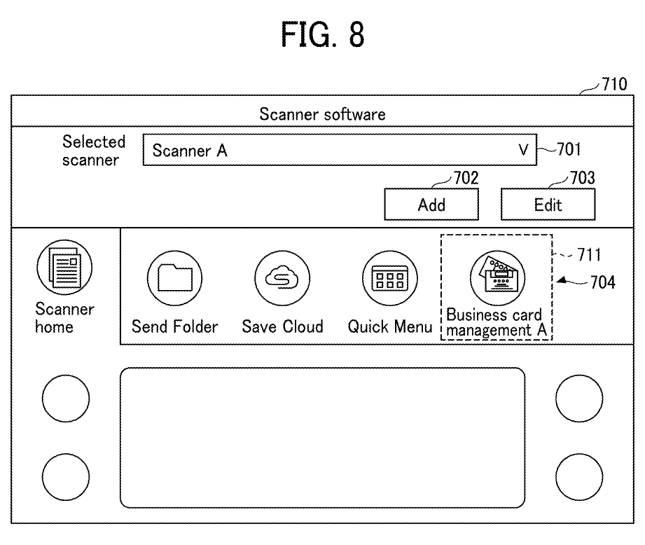

FIG. 8 is a second diagram illustrating an example of the screen of the scanner software. FIG. 8 illustrates an example of the screen of the scanner software displayed after a profile is distributed. As illustrated in FIG. 8, a screen 710 of the scanner software displayed after the profile is distributed additionally includes information representing the distributed profile in the profile display area 704. The example illustrated in FIG. 8 additionally includes information 711 representing the profile for linking to the "business card management A", which is an example of the business card management service.

The profile display area 704 may display the new profile at a given timing. For example, the new profile may be displayed when the scanner software is started for the first time after the profile is stored in the storage unit 200. For example, the scanner software may monitor profiles stored in the storage unit 200 at predetermined time intervals. Upon detecting storage of a new profile, the scanner software may display the new profile.

### Procedure of Process

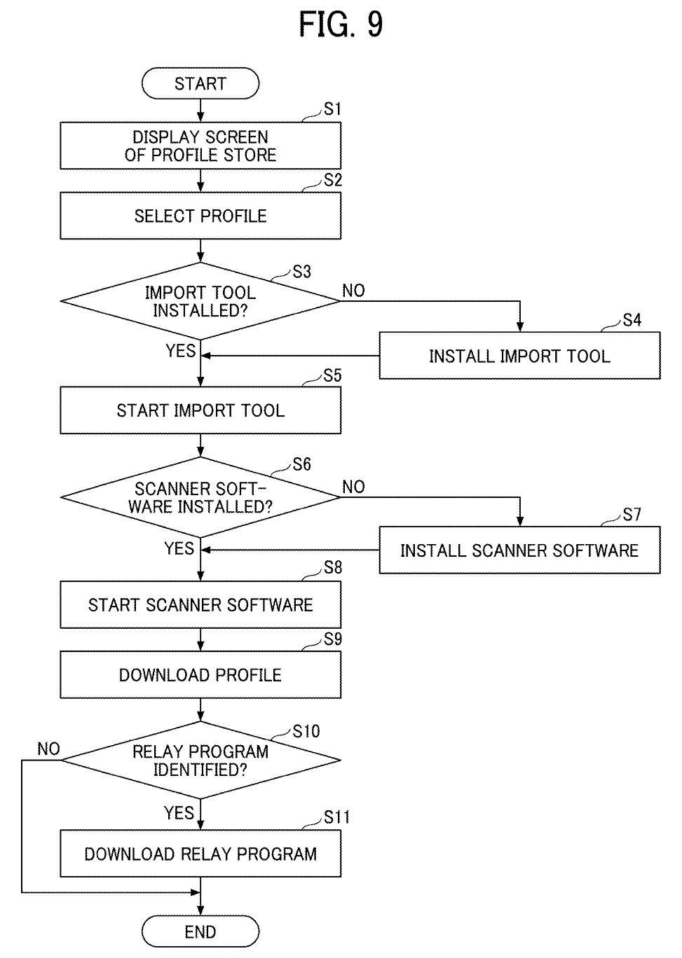

A procedure of a process performed by the profile distribution system 1000 will be described with reference to FIGS. 9 to 11. FIG. 9 is a flowchart of an example of a profile distribution method. FIG. 9 illustrates a procedure of a process performed by the user terminal 20 in the profile distribution method.

In step S1, in response to an operation by the user U, the user terminal 20 transmits an acquisition request to acquire the screen of the profile store to the distribution server 30. In response to the acquisition request received from the user terminal 20, the screen transmission unit 310 of the distribution server 30 transmits screen data for displaying the screen of the profile store to the user terminal 20. Based on the screen data received from the distribution server 30, the screen display unit 210 of the user terminal 20 displays the screen of the profile store on the display device 506.

In step S2, the operation receiving unit 220 of the user terminal 20 receives selection of a profile. Specifically, the operation receiving unit 220 receives pressing of the acquire button 622 on the detailed profile screen 620. The operation receiving unit 220 sends identification information of the selected profile to the setting information acquisition unit 230.

In step S3, the setting information acquisition unit 230 of the user terminal 20 receives the identification information of the profile from the operation receiving unit 220. The setting information acquisition unit 230 determines whether the import tool has been installed on the user terminal 20.

When the setting information acquisition unit 230 determines that the import tool has not been installed (NO in step S3), the process proceeds to step S4. When the setting information acquisition unit 230 determines that the import tool has been installed (YES in step S3), the process skips step S4 and proceeds to step S5.

In step S4, the setting information acquisition unit 230 of the user terminal 20 acquires the import tool. For example, the setting information acquisition unit 230 may download the import tool from the distribution server 30. Before downloading the import tool, the setting information acquisition unit 230 may display a screen requesting permission to download the import tool on the display device 506. The setting information acquisition unit 230 installs the import tool on the user terminal 20. For example, the setting information acquisition unit 230 may store the import tool in a predetermined directory of the storage unit 200.

In step S5, the setting information acquisition unit 230 of the user terminal 20 starts the import tool. The setting information acquisition unit 230 sends the identification information of the profile received in step S3 to the import tool.

In step S6, the import tool receives the identification information of the profile from the setting information acquisition unit 230. The import tool determines whether the scanner software has been installed on the user terminal 20.

When the import tool determines that the scanner software has not been installed (NO in step S6), the process proceeds to step S7. When the import tool determines that the scanner software has been installed (YES in step S6), the process skips step S7 and proceeds to step S8.

In step S7, the import tool acquires the scanner software. For example, the import tool may download the scanner software from the distribution server 30. Before downloading the scanner software, the import tool may display a screen requesting permission to download the scanner software on the display device 506. The import tool installs the scanner software on the user terminal 20. For example, the import tool may store the scanner software in a predetermined directory in the storage unit 200.

In step S8, the import tool starts the scanner software. The scanner software reads profiles stored in the storage unit 200. The scanner software displays the profiles read from the storage unit 200 on a screen.

In step S9, based on the identification information of the profile received in step S3, the setting information acquisition unit 230 of the user terminal 20 acquires the profile. For example, the setting information acquisition unit 230 may use the import tool to download the profile from the distribution server 30. The setting information acquisition unit 230 stores the profile in a predetermined directory of the storage unit 200.

In step S10, the setting information acquisition unit 230 of the user terminal 20 sends the profile acquired in step S9 to the program identification unit 240. Based on the profile received from the setting information acquisition unit 230, the program identification unit 240 identifies a relay program. For example, the program identification unit 240 acquires identification information of the relay program included in the profile.

The program identification unit 240 determines whether the relay program is identified. When the program identification unit 240 successfully identifies the relay program (YES in step S10), the process proceeds to step S11. When the program identification unit 240 fails to identify the relay program (NO in step S10), the process skips step S11 and the profile distribution method ends. Examples of the case where the program identification unit 240 fails to identify the relay program may include a case where the relay program identified based on the profile is not to be used or a case where the relay program identified based on the profile has already been stored in the storage unit 200.

In step S11, the program identification unit 240 of the user terminal 20 sends the identification information of the relay program acquired in step S10 to the program acquisition unit 250. The program acquisition unit 250 receives the identification information of the relay program from the program identification unit 240.

Based on the identification information of the relay program, the program acquisition unit 250 acquires the relay program. For example, the program acquisition unit 250 may use the import tool to download the relay program from the distribution server 30. The program acquisition unit 250 stores the relay program in a predetermined directory of the storage unit 200. The scanner software then displays the profile acquired in step S9 on the screen.

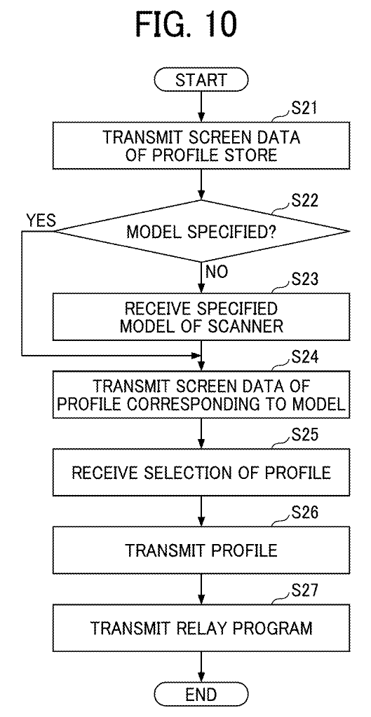

FIG. 10 is a flowchart of an example of the profile distribution method. FIG. 10 illustrates a procedure of a process performed by the distribution server 30 in the profile distribution method.

In step S21, in response to an operation by the user U, the user terminal 20 transmits an acquisition request to acquire the screen of the profile store to the distribution server 30. In response to the acquisition request received from the user terminal 20, the screen transmission unit 310 of the distribution server 30 transmits screen data for displaying the screen of the profile store to the user terminal 20. Based on the screen data received from the distribution server 30, the screen display unit 210 of the user terminal 20 displays the screen of the profile store on the display device 506.

In step S22, the screen display unit 210 of the user terminal 20 determines whether the model of the scanner 10 is specified on the screen of the profile store. When the screen display unit 210 of the user terminal 20 determines that the model of the scanner 10 is specified (YES in step S22), the process proceeds to step S24. When the screen display unit 210 of the user terminal 20 determines that the model of the scanner 10 is not specified (NO in step S22), the process proceeds to step S23.

In step S23, the operation receiving unit 220 of the user terminal 20 receives an operation to specify the model of the scanner 10 on the screen of the profile store. The screen display unit 210 may display a notification requesting the user to specify the model of the scanner 10 on the screen of the profile store. Examples of the notification requesting the user to specify the model of the scanner 10 include displaying a message prompting the user to specify the model of the scanner 10 and displaying an input field to receive specification of the model of the scanner 10 in an enhanced manner.

In step S24, the screen display unit 210 of the user terminal 20 transmits an acquisition request to acquire a screen corresponding to the model of the scanner 10 to the distribution server 30. In response to the acquisition request received from the user terminal 20, the screen transmission unit 310 of the distribution server 30 transmits screen data for displaying only profiles usable on the model of the scanner 10 to the user terminal 20. Based on the screen data received from the distribution server 30, the screen display unit 210 of the user terminal 20 displays only the profiles usable on the scanner 10 on the screen of the profile store. For example, the screen display unit 210 performs control to display the category display areas 601 including profiles usable on the scanner 10 on the category selection screen 600.

In step S25, the operation receiving unit 220 of the user terminal 20 receives an operation to select a profile on the screen of the profile store. The operation receiving unit 220 sends identification information of the selected profile to the setting information acquisition unit 230. The setting information acquisition unit 230 transmits a profile acquisition request to the distribution server 30. The profile acquisition request includes the identification information of the profile received from the operation receiving unit 220.

When the user terminal 20 does not have the import tool installed thereon, the user terminal 20 downloads the import tool from the distribution server 30 and stores the import tool in the predetermined directory of the storage unit 200. When the user terminal 20 does not have the scanner software installed thereon, the user terminal 20 downloads the scanner software from the distribution server 30 and stores the scanner software in the predetermined directory of the storage unit 200.

In step S26, the setting information transmission unit 320 of the distribution server 30 receives the profile acquisition request from the user terminal 20. The setting information transmission unit 320 reads the profile identified by the received profile acquisition request from the setting information storage unit 301. The setting information transmission unit 320 transmits the read profile to the user terminal 20.

The setting information acquisition unit 230 of the user terminal 20 receives the profile from the distribution server 30. The setting information acquisition unit 230 stores the received profile in the predetermined directory of the storage unit 200.

In step S27, based on the profile received in step S26, the program identification unit 240 of the user terminal 20 identifies the relay program. When the program identification unit 240 successfully identifies the relay program, the program identification unit 240 sends identification information of the identified relay program to the program acquisition unit 250. The program acquisition unit 250 transmits a relay program acquisition request to the distribution server 30. The relay program acquisition request includes the identification information of the relay program received from the program identification unit 240.

The program transmission unit 330 of the distribution server 30 receives the relay program acquisition request from the user terminal 20. The program transmission unit 330 reads the relay program identified by the received relay program acquisition request from the program storage unit 302. The program transmission unit 330 transmits the read relay program to the user terminal 20.

The program acquisition unit 250 of the user terminal 20 receives the relay program from the distribution server 30. The program acquisition unit 250 stores the received relay program in the predetermined directory of the storage unit 200.

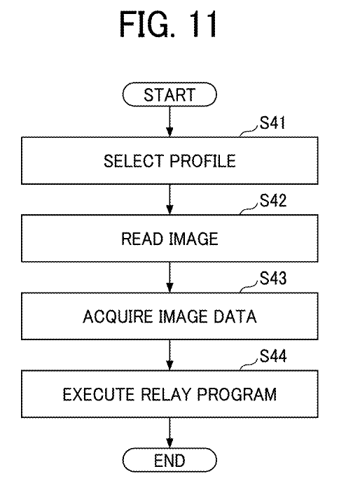

FIG. 11 is a flowchart of an example of an image reading method. FIG. 11 illustrates a procedure of processing electronic data generated by the scanner 10 based on the profile distributed using the profile distribution method.

In step S41, the operation receiving unit 220 of the user terminal 20 receives an operation of selecting a profile on the screen of the scanner software. The operation receiving unit 220 notifies the operation control unit 260 of the selected profile.

In step S42, the operation control unit 260 of the user terminal 20 receives the notification about the profile from the operation receiving unit 220. The operation control unit 260 reads the notified profile from the storage unit 200. Based on the read profile, the operation control unit 260 controls the operation of the scanner 10. The scanner 10 reads an image formed on an image forming medium. The scanner 10 generates image data of the image read from the image forming medium. The scanner 10 may perform predetermined data processing on the image data of the image read from the image forming medium to generate a processing result of the data processing.

In step S43, the scanner 10 transmits the image data generated in step S42 or the processing result of the image data to the user terminal 20. The operation control unit 260 of the user terminal 20 receives the image data or the processing result of the image data from the scanner 10.

In step S44, the operation control unit 260 of the user terminal 20 sets information related to the image data or the processing result of the image data received in step S43 in the relay program. The operation control unit 260 executes the relay program in which the information related to the image data or the processing result of the image data is set.

The relay program processes the image data or the processing result of the image data together with the predetermined link application. For example, the relay program transmits the image data or the processing result of the image data to the link server 40 using a communication scheme requested by the link application. For example, the relay program converts the image data into image data having an image quality or image data in a file format to enable linking to the link application, and transmit the resulting image data to the link server 40.

According to the present embodiment, the user terminal 20 acquires setting information related to an application that processes electronic data generated by an electronic device. The user terminal 20 identifies a program for using the application, based on the setting information, and acquires the identified program.

In one aspect, the present embodiment omits the necessity of separately acquiring the program for using the application when a profile including a setting related to the application is acquired. Thus, the present embodiment improves the convenience in acquisition of the setting information related to the electronic device.

The user terminal 20 may download the setting information from the distribution server 30 that is accessible from the user terminal 20 via a communication network. In one aspect, the present embodiment makes it easier to acquire the setting information via the communication network.

The user terminal 20 may display a screen presenting the setting information stored in the distribution server 30. In one aspect, the present embodiment makes it easier to check the acquirable setting information.

The user terminal 20 may download the setting information selected on the screen. In one aspect, the present embodiment makes it easier to acquire the setting information desired by the user.

The screen may display a method for using the application and the setting information that implements the method. In one aspect, the present embodiment makes it easier to acquire the setting information suitable for the use desired by the user.

The user terminal 20 may download a program from a storage device that is accessible from the user terminal 20 via a communication network. In one aspect, the present embodiment makes it easier to acquire a program for using the application via the communication network.

The user terminal 20 may acquire identification information of the program included in the setting information to identify the program. In one aspect, the present embodiment makes it possible to identify the program based only on the setting information.

The identification information of the program may include location information indicating a location of the program on the communication network. In one aspect, the present embodiment makes it possible to identify an acquisition method of the program based only on the setting information.

The electronic device may include an image reading device. In one aspect, the present embodiment improves the convenience in acquisition of the setting information related to the image reading device.

The program may be for transmitting image data generated by the image reading device to a link server 40 that executes the application. In one aspect, the present embodiment makes it easier to support a communication scheme requested by the application.

The program may be for correcting the image data generated by the image reading device into image data having an image quality corresponding to the application. In one aspect, the present embodiment makes it easier to support the image quality requested by the application.

The program may be for converting image data generated by the image reading device into image data in a file format corresponding to the application. In one aspect, the present embodiment makes it easier to support the file format requested by the application.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A non-transitory recording medium storing a plurality of instructions which, when executed by one or more processors on an information processing apparatus, causes the one or more processors to perform a method comprising:
acquiring setting information related to an application that processes electronic data generated by an electronic device;
identifying a program to be executed to use the application based on the setting information; and
acquiring the identified program.

2. The non-transitory recording medium according to claim 1, wherein the acquiring of the setting information includes downloading the setting information from a storage device that is accessible via a communication network.

3. The non-transitory recording medium according to claim 2, wherein the method further comprises:
displaying a screen presenting the setting information stored in the storage device.

4. The non-transitory recording medium according to claim 3, wherein the acquiring of the setting information includes downloading the setting information selected on the screen.

5. The non-transitory recording medium according to claim 4, wherein the screen displays a method for using the application and the setting information that implements the method for using the application.

6. The non-transitory recording medium according to claim 1, wherein the acquiring of the program includes downloading the program from a storage device that is accessible via a communication network.

7. The non-transitory recording medium according to claim 6, wherein the identifying of the program includes acquiring identification information of the program included in the setting information.

8. The non-transitory recording medium according to claim 7, wherein the identification information includes location information indicating a location of the program on the communication network.

9. The non-transitory recording medium according to claim 1, wherein the electronic device includes an image reading device to read an image into image data, the image data being the electronic data.

10. The non-transitory recording medium according to claim 9, wherein the program acquired in the acquiring of the program transmits the image data generated by the image reading device to another information processing apparatus that executes the application.

11. The non-transitory recording medium according to claim 9, wherein the program acquired in the acquiring of the program corrects the image data generated by the image reading device into image data having an image quality corresponding to the application.

12. The non-transitory recording medium according to claim 9, wherein the program acquired in the acquiring of the program converts the image data generated by the image reading device into image data in a file format corresponding to the application.

13. An information processing apparatus comprising circuitry configured to:
acquire setting information related to an application that processes electronic data generated by an electronic device;
identify a program to be executed to use the application based on the setting information; and
acquire the identified program.

14. An electronic device comprising circuitry configured to:
generate electronic data;
acquire setting information related to an application that processes the electronic data;
identify a program to be executed to use the application based on the setting information; and
acquire the identified program.

15. An information processing apparatus comprising circuitry configured to:
transmit setting information related to an application that processes electronic data generated by an electronic device to another information processing apparatus; and
transmit a program to be executed to use the application to said another information processing apparatus, wherein
the setting information includes information for identifying the program.

16. The information processing apparatus according to claim 15, wherein the circuitry is configured to transmit image data for displaying a screen presenting the setting information to said another information processing apparatus.

17. The information processing apparatus according to claim 16, wherein the screen displays the setting information usable by the electronic device.

18. The information processing apparatus according to claim 16, wherein the screen displays a method for using the application and the setting information that implements the method for using the application.
